(19) United States
(12) Patent Application Publication
(10) Pub. No.: US 2026/0014664 A1
(43) Pub. Date: Jan. 15, 2026

(54) A GRINDING AND/OR POLISHING MACHINE AND A SPECIMEN HOLDER

(71) Applicant: Struers ApS, Ballerup (DK)

(72) Inventors: Thyge FROLUND, Ballerup (DK); Thomas MATSCHOFSKY, Ballerup (DK)

(21) Appl. No.: 18/881,359

(22) PCT Filed: Jan. 12, 2023
(86) PCT No.: PCT/EP2023/050626

§ 371 Date: Jan. 6, 2025

(30) Foreign Application Priority Data
Jul. 8, 2022 (DK) PA202270367

(51) Int. Cl. B24B 37/10; B24B 37/30

(52) U.S. Cl. CPC B24B 37/107; B24B 37/30

(57) ABSTRACT

The present invention relates to a grinding and/or polishing machine (1) with a rotatable specimen holder (20) and a rotatable disc (8) for supporting a preparation surface (6), the specimen holder (20) comprising a housing (25) having a housing face (40) oriented towards the rotatable disc (8) and at least sixty-four pins (30) having each a portion (36) projecting from the housing face (40), the pins (30) being individually movable into the housing (25) against the action of a resilient member (60) arranged in the housing (25).

For the purpose of materialography, materialographic specimens, i.e. pieces of a material such as metal, are typically cut off a larger sample by an abrasive cut off wheel in, for example, a materialographic cutting machine.

After the specimen has been cut off, the specimen needs to be prepared for examination in one or more steps of grinding and/or polishing. The grinding and/or polishing typically takes place in a dedicated grinding and/or polishing machine where one or more of such specimens are placed in a specimen holder which is rotated, with the specimens pressed against a preparation surface, which preparation surface itself often is rotated. Such preparation surfaces are typically defined by a polishing or grinding pad or cloth arranged on a rotating support disc, whereby the pad rotates together with the support disc.

The grinding and/or polishing machines are typically configured to press the specimens against the preparation surface. Often, the axis of rotation of the specimen holder is offset relative to the axis of rotation of the preparation surface, both axes being vertical.

An example of such a grinding and/or polishing machine is shown in WO2016/146557 where each specimen is held in place relative to the specimen holder by the latter having respective holes for receiving and holding a specimen and where each specimen is pressed against the preparation surface by a respective spring-loaded pin mounted to a machine head. The machine head is moved up and down relative to the driveshaft that rotates the specimen holder.

Prior art specimen holders generally suffer from the disadvantage that they either need to be designed for use with specimens of a specific geometry/contour or require an operator to manually secure the specimen to the specimen holder, such as by tightening cross-wise extending fixing screws; this is time-consuming.

Hence, there is a need for a more versatile specimen holder for faster use, and a grinding and/or polishing machine having such a more versatile specimen holder, where specimens of many different geometries can be processed using the same specimen holder, with the specimen holder pressing the specimens against the preparation surface.

### SUMMARY

In view of this object, a specimen holder as defined in claim 1 is provided.

Specifically, the present invention concerns a grinding and/or polishing machine with a rotatable specimen holder and a rotatable disc for supporting a preparation surface, the specimen holder comprising a housing having a housing face oriented towards the rotatable disc and at least sixty-four pins having each a portion projecting from the housing face, the pins being individually movable into said housing against the biasing force of a resilient member arranged in the housing.

The grinding and/or polishing machine is configured for applying a vertical pressure on the specimens by lowering the specimen holder to sandwich the specimens between the preparation surface and corresponding groups of the pins. The pins of the corresponding groups are thereby pressed into the housing by direct contact of the upper surface of the specimens with end faces of the pins, establishing a downward pressure on the specimens depending on the degree to which the pins are pressed into the housing against the resilient member. On the other hand, other pins will surround each specimen and extend along the sides of the specimens, to thereby hold and limit or prevent any sideways movement of the specimens relative to the housing when the specimen holder is rotated.

The invention also concerns a method of operating the grinding and/or polishing machine.

Claims are also directed to the specimen holder for a grinding and/or polishing machine as such. In an embodiment thereof the resilient member is a respective compression spring acting on a corresponding one of the pins and selected such that a joint 2 mm movement into the housing of all pins within a 100cm² area of the housing face requires a total force of at least 140N.

Preferred embodiments are defined in the dependent claims. Preferably, the movable pins are uniformly distributed across the housing face, including in an area thereof through which the axis of rotation of the specimen holder passes, the uniform distribution preferably being such that an area of size 100 cm² has between sixty or seventy pins, or even more pins, arranged such that neighbouring pins are at the same distance from one another throughout that area. This typically allows for specimens to be held by the specimen holder at any desired place across the face of the housing.

### BRIEF DESCRIPTION OF THE DRAWINGS

FIG. 1 is a perspective view of a machine with a specimen holder according to the invention,

FIG. 2 is a bottom perspective view of the specimen holder,

FIG. 3 is a bottom view of the specimen holder, illustrating three specimens pressing pins against a resilient member of the specimen holder,

FIG. 4 is an enlarged partial cross-sectional view of the specimen holder shown in FIG. 3, in a configuration where the specimens are pressed against a preparation surface,

FIG. 5 is another cross-sectional view of the specimen holder shown in FIG. 3, in a configuration where the specimens are pressed against a preparation surface, and

FIGS. 6a and 6b are cross-sectional views of the machine, showing the machine in two states of operation.

### DETAILED DESCRIPTION

The invention will now be explained in more detail below by reference to a preferred embodiment.

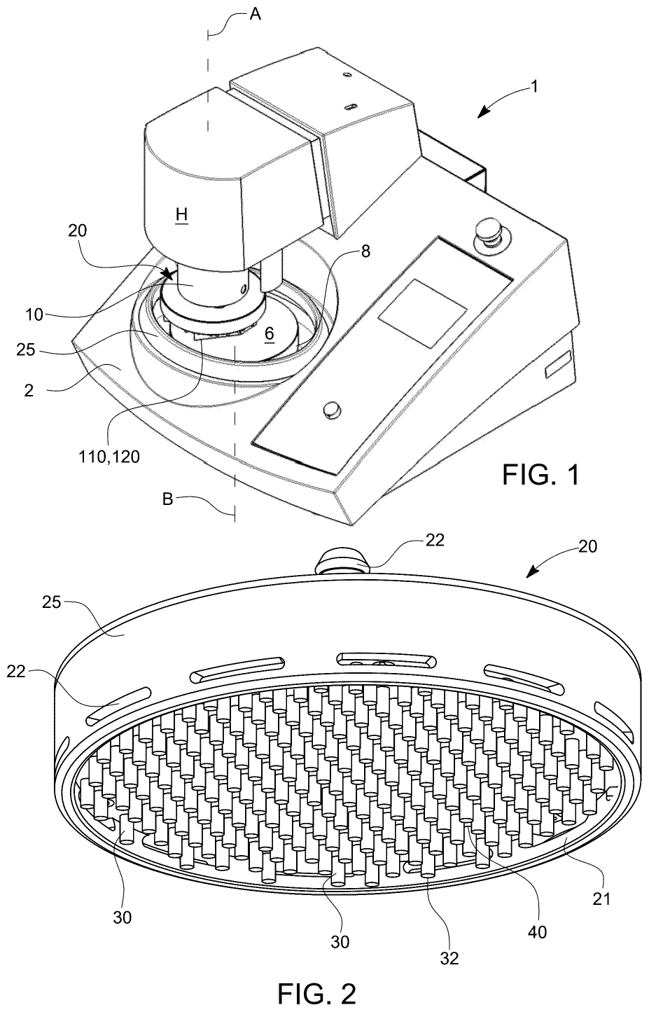

FIG. 1 shows a grinding and/or polishing machine 1 where one or more specimens 110, 120 are being held by a specimen holder 20 of the invention. The specimen holder 20 is connected to a driveshaft 10 of the machine 1 whereby the specimen holder 20 together with the specimens 110, 120 may be rotated about a vertical axis A. The specimen holder 20 has a circular outline or contour, with its center coincident with the axis A.

A preparation surface 6, against which the specimens 110, 120 are being pressed by the specimen holder 20, is preferably simultaneously rotated about another vertical axis B that is offset relative to the axis A of rotation of the specimen holder 20.

The preparation surface 6 is typically defined by a replaceable polishing or grinding pad or cloth arranged on a rotating support disc 8, whereby the pad 6 rotates together with the support disc 8.

The grinding and/or polishing machine 1 is configured for applying a vertical pressure on the specimens 110, 120 by lowering the specimen holder 20 to sandwich the specimens 110, 120 between the preparation surface 6 and corresponding groups of pins 30 projecting from a housing 25 of the specimen holder 20, as explained in the following. To assist an operator in correctly positioning the specimens 110, 120 on the preparation surface 6 within the contour of the specimen holder 20 a machine head H with the motor for rotating the driveshaft 10 may provide a light curtain partially or fully illuminating a corresponding portion of the preparation surface 6.

The novel specimen holder 20 comprises, as shown in FIG. 2, a housing 25 with a coupling 22 for connecting the specimen holder 20 to the driveshaft 10 of the machine 1, and a two-dimensional array of elongate pins 30 having each an end face 32. A length of each pin 30 projects from a flat, lower face 40 of the housing 25. The pins 30 are configured to be independently movable into the housing 25, against the action of a resilient member; FIG. 2 shows the specimen holder 20 with the pins 30 in their normal state wherein they all project by an equal length from the lower face 40. The pins 30 are preferably cylindrical and preferably have a flat end face 32. A number of pins 30 in the order of at least one hundred has been found suitable for many grinding and/or polishing applications.

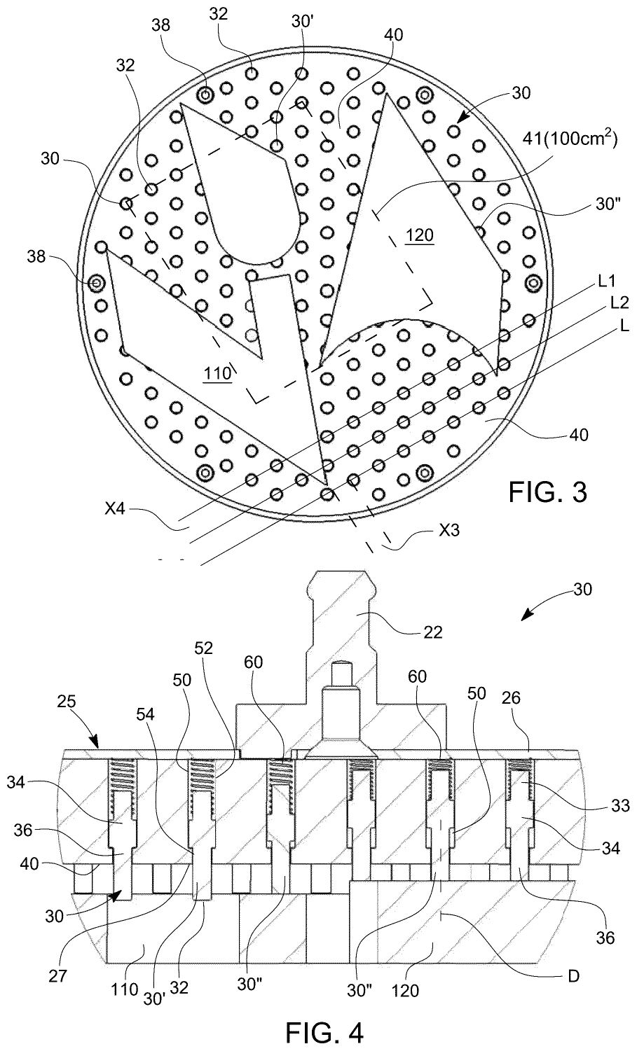

Preferably, as shown in FIG. 3, the pins 30 are identical and arranged in parallel rows or lines L, L1, L2, equally spaced from each other by a distance X3 in each row/along each line L, L1, L2. Preferably, the pins 30 in/along any of two neighbouring rows/lines L1, L2 are offset so that pins 30 along one line L1 are located halfway between the pins 30 of the neighbouring line L2. Other patterns or arrangements of the pins 30 may be foreseen but preferably, as 30 shown, the pins 30 are uniformly distributed across the lower face 40.

FIG. 3 shows several specimens 110, 120, having different contours and contacting the end faces 32 of pins 30 of three corresponding groups of pins 30.

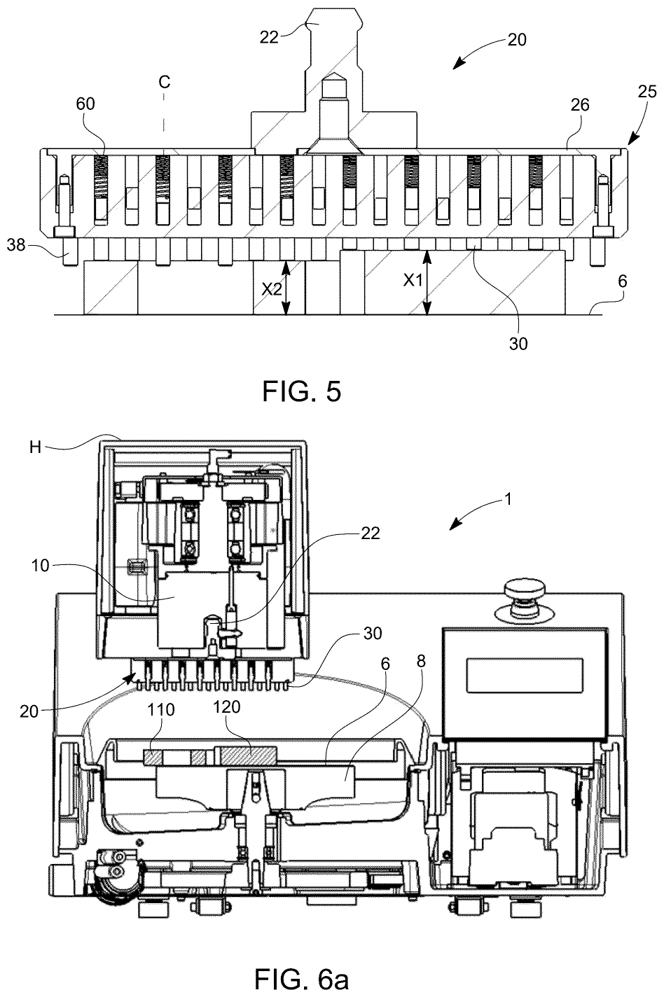

As shown in FIGS. 4 and 5 the housing 25 has a plurality of bores 50, each receiving and guiding a respective cylindrical pin 30. Each bore 50 has a first portion 52 and a second portion 54 of a smaller diameter, wherein the second portion 54 extends to a respective opening 27 formed in the lower face 40 of the housing 25 while the first portion 52 is closed at one end, such as by a removable cover plate 26 of the housing 25.

Each bore 50 preferably is cylindrical, and has a central axis C coincident with the central axis D of the pin 30 received in the bore 50; all pins 30 of the array are arranged such that their respective axes D are parallel with one another.

In one embodiment the area of the lower face 40 is 195 cm² and a total of 208 cylindrical pins are used, with a respective pin diameter of 4 mm. When reference is made herein to the area of the lower face 40, or the area of a portion of the lower face 40, such as the area 41 shown in FIG. 3, that area is determined as the area of the footprint within the demarcating line, i.e. without subtracting the area of the openings 27 formed in the lower face 40.

As seen best in FIG. 4, each pin 30 has a first, large diameter section 34, having a diameter larger than that of the second portion 54 of the corresponding bore 50, and which is received inside the first portion 52 of the bore 50, wherein the first section 34 is retained in the housing 25 between the cover plate 26 and the second portion 54 of the bore 50.

The aforementioned resilient member, referenced herein by numeral 60, acts on each pin 30, to force a second section 36 thereof to normally project from the face 40 of the housing 25, through a corresponding housing opening 27, as shown clearly in FIG. 2. The resilient member may be defined by one or more elastic pads arranged in the housing 25 between the cover plate 26 and the bores 50 to act on one or several pins 30, or a respective compression spring 60, shown in FIGS. 4 and 5, may be associated with each pin 30. In the latter case the respective spring 60 is preferably arranged in the first portion 52 of each bore 50 to bear against the large diameter section 34 of the pin 30, to force the second portion section thereof to normally project from the lower face 40 of the housing 25. The housing 25 may be so configured that a complete depression of the pins 30 by their full length into the receiving bores 50 is not possible.

In operation, as shown in FIGS. 4 and 5, the specimen holder 20 is lowered against specimens 110, 120 arranged on the preparation surface 6, with pins 30″ of corresponding groups being thereby pressed into the housing 25 by direct contact of the upper surface of the specimens 110, 120 with the end faces 32 of the pins 30″ of the corresponding group of pins 30″. Pins 30′ surrounding the specimen 110, 120 are not affected and, hence, extend along the sides of the specimen 110, 120 to thereby hold and limit or prevent any sideways movement of the specimens 110, 120 relative to the housing 25 when the specimen holder 20 is rotated about the axis A. Hence, some of the pins 30″ serve to press a given specimen 110, 120 against the preparation surface 6, by a force that is determined by the extent to which the specimen holder 20 is lowered towards the preparation surface 6 and by the spring constant of the springs 60. For an advantageous pressing of specimens 110, 120 against the preparation surface 6 the compression springs 60 are preferably selected such that a joint 2 mm movement into the housing of all pins 30 within a 100 cm² area 41 of the lower face 40 requires a total force of at least 140N. Preferably, the all springs 60 are identical in having the same stiffness.

As shown in FIG. 2 the housing 25 may preferably have a fixed peripheral skirt 21 serving also to limit sideways movement of the specimens 110, 120; the skirt 21 may as shown have apertures 22 useful for radial discharge of fluids in a later housing 25 rinsing process. Lowering of the specimen holder 20 towards the support disc 8 is preferably restricted to prevent inadvertent direct contact between the pins 30 and the skirt 21 with the preparation surface 6.

In FIG. 5 is shown how specimens 110, 120 may have different heights X1, X2 perpendicular to the preparation surface 6. In such cases a higher force will be applied by pins 30″ contacting the higher specimen 120 since the corresponding spring 60 is compressed to a higher degree than other pins 30″ contacting the lower specimen 110. The remaining pins 30′ that are unaffected will extend along a larger portion of the higher specimen 120. Preferably, the specimen holder 20 is so configured that the pins 30′ will extend by at least 2 mm along the sides of the specimens 110, 120 (perpendicularly to the support disc 8), to ensure a good sideways hold on the specimens 110, 120, and this by providing eg. a stop inside the bores 50 to limit the maximum displacement of the pins 30.

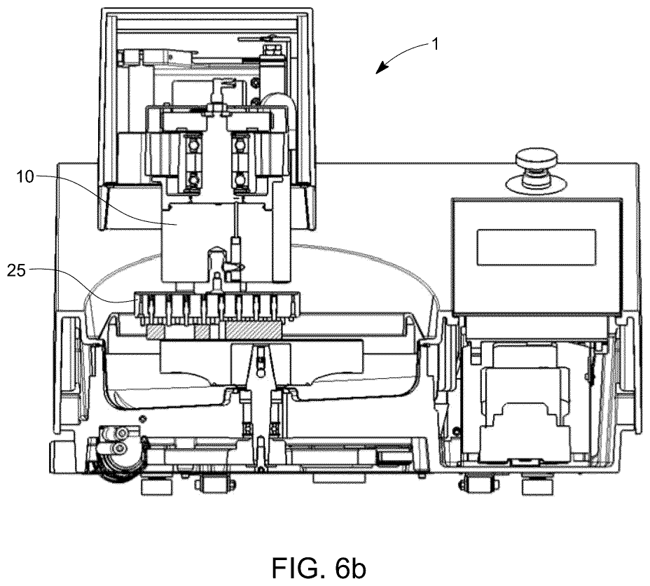

FIGS. 6a and 6b are cross-sectional views showing the machine in a first position before use, wherein the specimen holder 20 is in a raised position above two specimens 110, 120 arranged on the support disc 8 within the contour of the specimen holder 20. The driveshaft 10 is then lowered, as shown in FIG. 6b, until sufficient pressure is established against the upper surface of each specimen 110, 120, after which operation of the machine 1 is started to initiate the grinding/polishing procedure.

It will be understood that the machine 1 is preferably so configured that rotation of the specimen holder 20 cannot be started before the correct pressure against the specimens 110, 120 is achieved. Moreover, means may preferably be provided to stop the machine 1 in the event that the specimen holder 20 is advanced towards the preparation surface 6 to such an extent during grinding that there is a risk of contact between the ends 32 of the pins 30 and the preparation surface 6 or any peripheral skirt 21 surrounding the array of pins 30.

1. A grinding and/or polishing machine with a rotatable specimen holder and a rotatable disc for supporting a preparation surface, said specimen holder comprising a housing having a housing face oriented towards said rotatable disc and at least sixty-four pins having each a portion projecting from said housing face, said pins being individually movable into said housing against the action of a resilient member arranged in said housing.

2. The machine of claim 1, said movable pins being uniformly distributed across said housing face.

3. The machine of claim 1, said specimen holder comprising at least eight adjacent parallel rows (L, L1, L2) of said pins, at least eight pins defining each of said at least eight rows (L, L1, L2) of pins.

4. The machine according to the previous claim 3, wherein said pins are arranged at the same distance (X3) from one another in at least one, of said rows (L, L1, L2).

5. The machine according to claim 3, wherein said rows (L, L1, L2) are spaced apart by the same distance (X4).

6. The machine according to claim 1, said housing having a circular contour and including at least one hundred of said pins.

7. The machine according to claim 1, wherein an area of size 100 cm² of said housing face includes between sixty and seventy of said pins, or even more pins, an axis (A) of rotation of said specimen holder preferably passing through said area.

8. The machine according to claim 1, said pins being identical and having each a cross-sectional area in the order of 6-115 mm².

9. The machine according to claim 1, wherein said pins have a circular cross section.

10. The machine according to any of the previous claims claim 1, said resilient member being one or more elastic pads of an elastomeric material, arranged in said housing between a cover plate and said pins to act on a plurality of said pins.

11. The machine according to claim 1, said resilient member being a respective compression spring associated with each pin.

12. The machine according to claim 1, said housing having a plurality of bores receiving each a respective cylindrical pin, and having a first portion and a second portion of reduced diameter, wherein the second portion extends to said housing face, said first portion being closed at one end, such as by a cover plate of said housing.

13. The machine according to claim 12, each pin having a first section having a diameter larger than that of said second portion of said bores, arranged inside said first portion of said bores, wherein said first section is retained in the housing between said cover plate and said second portion of said bores.

14. The machine according to claim 1, said bores having a central axis (C) coincident with a central axis (D) of said pins, all of said pins being arranged such that their axes (D) are parallel with one another.

15. The machine according to claim 1, including further pins arranged along a circular contour of said housing, said further pins being immovable.

16. The machine according to claim 1, said resilient member being selected such that a joint 2 mm movement into said housing of all of said pins within a 100 cm² area of said housing face requires a total force of at least 140N.

17. The machine according to claim 1, wherein rotation of said rotatable disc can be initiated only when a selected pressure is applied by said pins against said specimen(s).

18. A method of operating the machine of claim 1, comprising the steps of i) arranging one or more specimens within a portion of the preparation surface below said specimen holder, and ii) lowering said specimen holder for a first plurality of said pins to contact an upper surface of each specimen while moving inside said housing and for a second plurality of said pins to extend along sides of said specimens.

19. A specimen holder, comprising a housing having a housing face and at least sixty-four pins, having each a portion projecting from said housing face, said pins being individually movable into said housing against the action of a resilient member arranged in said housing.

20. The specimen holder of claim 19, said movable pins being uniformly distributed across said housing face.

21. The specimen holder of claim 19, comprising at least eight adjacent parallel rows (L, L1, L2) of said pins, at least eight pins defining each of said at least eight rows (L, L1, L2) of pins.

22. The specimen holder according to claim 21, wherein said pins are arranged at the same distance (X3) from one another in at least one, preferably all, of said rows (L, L1, L2).

23. The specimen holder according to claim 21, wherein said rows (L, L1, L2) are spaced apart by the same distance (X4).

24. The specimen holder according to claim 19, said housing having a circular contour and including at least one hundred of said pins.

25. The specimen holder according to claim 19, wherein an area of size 100 cm² of said housing face includes between sixty and seventy of said pins, an axis (A) of rotation of said specimen holder passing through said area, said pins arranged such that neighbouring pins are at the same distance from one another throughout that area.

26. The specimen holder according to claim 19, said resilient member being selected such that a joint 2 mm movement into said housing of all of said pins within a 100 cm² area of said housing face requires a total force of at least 140N.

27. The specimen holder according to claim 19, said resilient member being a respective compression spring associated with each pin.
